(19) United States
(12) Patent Application Publication
(10) Pub. No.: US 2008/0314669 A1
(43) Pub. Date: Dec. 25, 2008

(54) MOTORCYCLE AIRBOX WITH FLOW-ENHANCING SHAPE

(75) Inventor: Erik F. Buell, Mukwonago, WI (US)

Correspondence Address: MICHAEL BEST & FRIEDRICH LLP, 100 E WISCONSIN AVENUE, Suite 3300, MILWAUKEE, WI, 53202, US

(73) Assignee: BUELL MOTORCYCLE COMPANY, East Troy, WI (US)

(21) Appl. No.: 11/765,526

(22) Filed: Jun. 20, 2007

(51) Int. Cl. F02M 35/10; B62J 11/00

(52) U.S. Cl. 180/219; 123/184.21

(57) ABSTRACT

A motorcycle having a frame, at least two wheels mounted for rotation relative to the frame, an engine coupled to the frame, and an air intake system coupled to the engine. The air intake system includes an intake port having an intake axis along which air enters the intake port, and an airbox having an inlet opening in communication with the atmosphere and an outlet opening in communication with the intake port. The airbox further includes a contoured baffle positioned adjacent the intake port and adapted to guide air from the inlet opening toward and into the intake port. The contoured baffle preferably includes a guide surface (e.g., a three-dimensionally contoured surface that approximates a tractroid) positioned substantially in alignment with the intake axis. For example, a least one tangent line of the guide surface can pass through the intake port.

### BACKGROUND

The present invention relates to motorcycles, and particularly to air intakes and airboxes on motorcycles.

Like any vehicle with a internal combustion engine, motorcycles must use air in order to operate. Air intake systems on motorcycles typically include an airbox ha an inlet opening that draws air from the atmosphere and an outlet opening that allows the air to enter the throttle body of the engine. An air filter is commonly positioned in the airbox between the inlet opening and the outlet opening in order to remove debris from the air before it enters the engine.

### SUMMARY

The present invention provides a motorcycle having a frame, at least two wheels mounted for rotation relative to the frame, an engine coupled to the frame, and an air intake system coupled to the engine. The air intake system includes an intake port having an intake axis along which air enters the intake port, and an airbox having an inlet opening in communication with the atmosphere and an outlet opening in communication with the intake port. The airbox further includes a contoured baffle positioned adjacent the intake port a adapted to guide air from the inlet opening toward into the intake port.

In one embodiment, the airbox comprises a base housing and a cover housing detachably coupled to the base housing. In this embodiment, it is preferred to have the inlet opening formed in the base housing, and it is also preferred to have the contoured baffle coupled to (e.g. integral with) the cover housing. The contoured baffle preferably includes a guide surface (e.g., a three-dimensionally contoured surface that approximates a tractroid) positioned substantially in alignment with the intake axis. For example, at least one tangent line of the guide surface can pass through the intake port.

Other aspects of the invention will become apparent by consideration of the detailed description and accompanying drawings. Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used here is for the purpose of description and should not be regarded as limiting. The use of “including,” “comprising” or “having” and variations thereof herein is meant to encompass the items listed thereafter and equivalents thereof as well as additional items. Unless specified or limited other the terms “mounted,” “connected,” “supported,” and “coupled” and variations thereof are used broadly and encompass both direct and indirect mountings connections, supports, and couplings. Further, “connected” and “coupled” are not restricted to physical or mechanical connections or couplings.

### BRIEF DESCRIPTION OF THE DRAWINGS

FIG. 1 is a side view of a motorcycle embodying various aspects of the present invention;

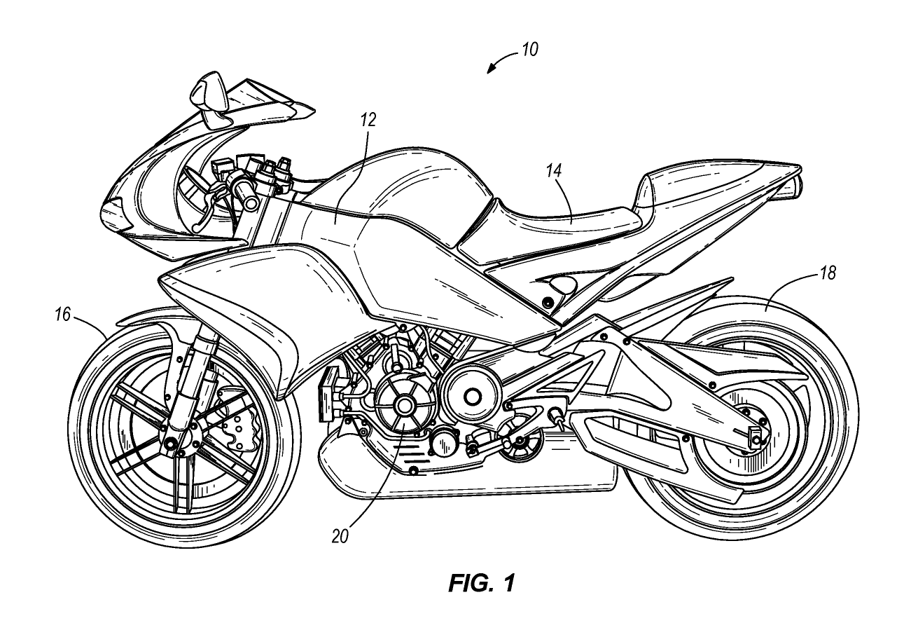

FIG. 2 is an exploded perspective view of the airbox assembly of FIG. 1;

FIG. 3 is a vertical section view taken along line 3-3 in FIG. 2; and

FIG. 4 is a section view taken along line 4-4 in FIG. 2.

### DETAILED DESCRIPTION

The illustrated motorcycle 10 includes a main 12, a seat 14, a front wheel 16, a rear wheel 18, and an engine 20. The engine 20 provides power to the rear wheel 18 through a transmission.

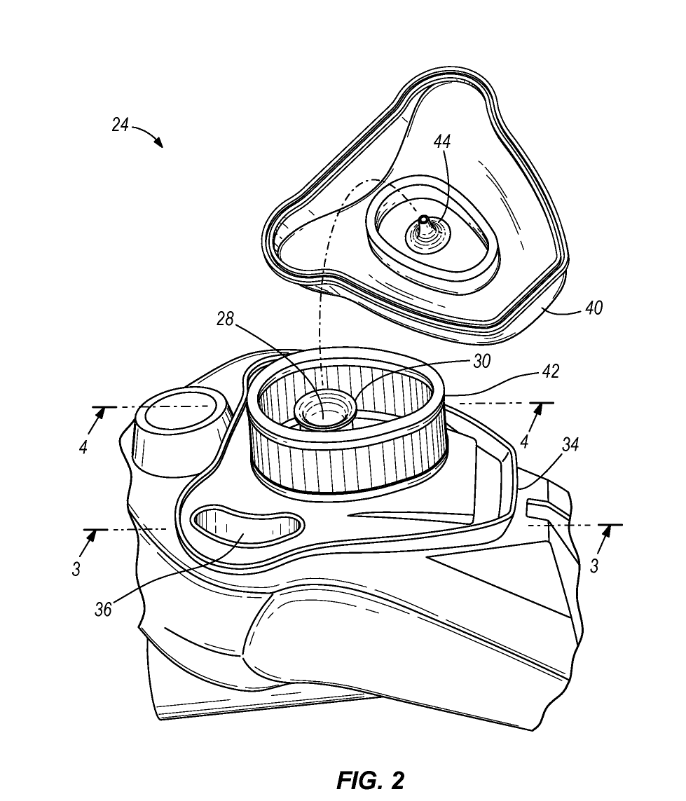

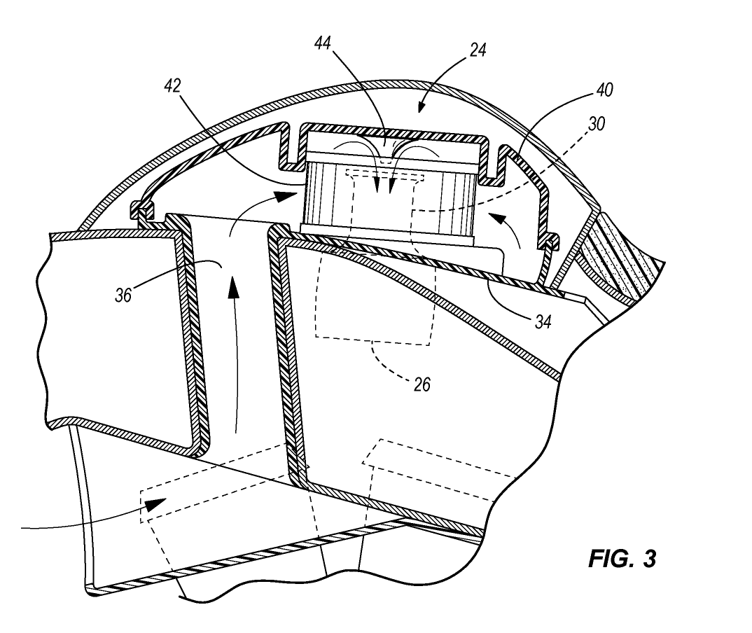

Referring to FIGS. 2-4, the illustrated motorcycle 10 also includes an air intake system 24 that is coupled to the engine 20 and is designed to provide a source of clean, fresh air to the engine for the combustion process. The air intake system 24 includes an intake manifold 26 coupled to the engine 20. The intake manifold 26 includes a intake port 28 having a diameter D and formed by a converging nozzle 30 for guiding air into the engine 20. The illustrated air intake system also includes an airbox communicating with the intake manifold 26. The illustrated airbox includes a base housing 34 hang a inlet opening 36 for receiving air from the atmosphere. The nozzle 30 extends up through the base housing 34. A cover housing 40 is attached to the base housing 34 to form an enclosed and substantially air tight airbox. An air filter 42 is positioned between the inlet opening 36 and the nozzle 30 to filter the air entering the intake port 28.

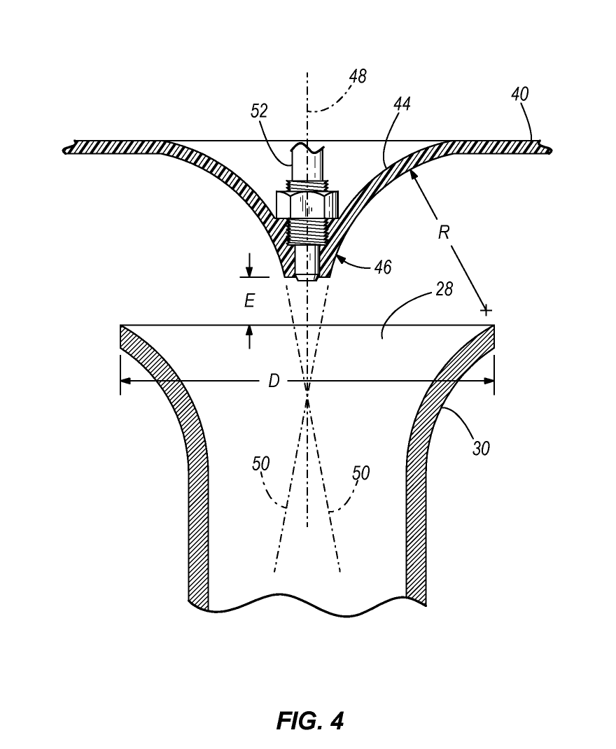

The cover housing 40 is provided with a baffle 44 that is positioned above and is aligned with the intake port 28. In the illustrated embodiment, the baffle 44 is formed integrally with the cover housing 40. The baffle 44 includes a guide surface 46 that is aligned with the intake port 28 such that air passing through the airbox will be guided along the guide surface 46 and toward the intake port 28. The guide surface 46 is substantially aligned with a intake axis 48 of the intake manifold 26 and is positioned at a elevation E above the nozzle 30. The ratio of the elevation E to the diameter D is less than about 0.5, preferably less than about 0.25, and in the illustrated embodiment is about 0.125. The illustrated guide surface 46 has a radius R, and is contoured in a shape that approximates a truncated tractroid that is capable of guiding air from multiple directions. The ratio of the radius R to the diameter D is less than about 1.0, preferably less than about 0.7, and in the illustrated embodiment is about 0.4. The baffle 44 is positioned such that a tangent line 50 from the truncated end of the guide surface 46 will pass through the intake port 28 of the intake manifold 26, as best illustrated in FIG. 4. In the illustrated embodiment, opposing tangent limes 50 intersect in the space defined by the nozzle 30.

In operation, the engine 20 will draw air through the airbox 32 and intake manifold 26. The air will enter the inlet opening 36 of the airbox 32 and pass through the air filter 42, where particles in the air will be filtered The air then moves toward the baffle 44 and will be guided by the guide surface 46 and into the intake port 29 of the intake manifold 26.

The illustrated embodiment also includes a fuel injector 52 positioned in the baffle 44 of the cover housing 40. The fuel injector 52 is positioned the apex of the baffle 44 and is positioned to direct fuel down into the intake manifold 26. In a preferred embodiment, the engine 20 is provided with a second fuel injector (not illustrated) inside the intake manifold 26. The second fuel injector provides fuel to the engine 20 during normal operation, and the upper fuel injector 52 can be utilized when extra fuel is required, such as during high power application.

What is claimed is:

1. A motorcycle comprising:
a frame;
at least two wheels mounted for rotation relative to the frame;
an engine coupled to the frame; and
an air intake system coupled to the engine and comprising:
an intake port having an intake axis along which air enters the intake port; and
an airbox having an inlet opening in communication with the atmosphere and an outlet opening in communication with the intake port, the airbox further comprising a contoured baffle positioned adjacent the port an adapted to guide air from the inlet opening toward and into the intake port.

2. The motorcycle of claim 1, wherein the airbox comprises a base housing and a cover housing detachably coupled to the base housing.

3. The motorcycle of claim 2, wherein the inlet opening is formed in the base housing.

4. The motorcycle of claim 2, wherein the contoured baffle is coupled to the cover housing.

5. The motorcycle of claim 4, wherein the contoured baffle is formed integrally with the cover housing.

6. The motorcycle of claim 1, wherein the airbox further comprises an air filter positioned to filter air passing from the inlet opening to the intake port.

7. The motorcycle of claim 1, wherein the contoured baffle include a guide surface positioned, substantially in alignment with the intake axis.

8. The motorcycle of claim 7, wherein the guide surface defines at least one tangent line that passes the intake port.

9. The motorcycle of claim 7, wherein the guide surface is three-dimensionally contoured to guide air from multiple directions into the intake port.

10. The motorcycle of claim 9, wherein the surface approximates a tractroid.

11. An air intake system for an internal combustion engine, the system comprising:
an intake port having an intake axis along which air enters the intake port; and
an airbox having an inlet opening and an outlet opening in communication with the intake port, the airbox further comprising a contoured baffle positioned adjacent the intake port and adapted to guide air from the inlet opening toward and into the intake port.

12. The air intake system of claim 11, wherein the airbox comprises a base housing and a cover housing detachably coupled to the base housing.

13. The air intake system of claim 12, wherein the inlet opening is formed in the base housing.

14. The air intake system of claim 12, wherein the contoured baffle is coupled to the cover housing.

15. The air intake system of claim 11, wherein the airbox further comprises an air filter positioned to filter air passing from the inlet opening to the intake port.

16. The air intake system of claim 11, wherein the contoured baffle includes a guide surface positioned substantially in alignment with the intake axis.

17. The air intake system of claim 16, the guide surface defines at least one tangent line that passes through the intake port.

18. The air intake system of claim 16 wherein the guide surface is three-dimensionally contoured to guide air from multiple directions into the intake port.

19. The air intake system of claim 18, wherein the guide surface approximates a tractroid.
